(19) United States
(12) Patent Application Publication
(10) Pub. No.: US 2001/0003625 A1
(43) Pub. Date: Jun. 14, 2001

(54) HEAT WELDABLE EPDM ROFFING MEMBRANE

(76) Inventors: JONATHAN W. APGAR, SYLVANIA, OH (US); MICHAEL J. HUBBARD, HOLLAND, OH (US); WALTER J. KELLY, WADSWORTH, OH (US); BARRY M. ROSENBAUM, SHAKER HEIGHTS, OH (US); ANTHONY VERROCCHI, AKRON, OH (US); RAYMOND J. WEINERT, MACEDONIA, OH (US)

Correspondence Address: GENCORP INC, 175 GHENT ROAD, FAIRLAWN, OH, 443333300

(21) Appl. No.: 09/197,741

(22) Filed: Nov. 20, 1998

(51) Int. Cl. B32B 3/00; B32B 27/32

(52) U.S. Cl. 428/519; 428/57; 156/334

(57) ABSTRACT

A heat weldable roofing membrane including a substrate sheet formed of ethylene-propylene diene monomer and a top film layer laminated to at least one surface of the substrate sheet and selected from TPE and TPO.

### FIELD OF THE INVENTION

The present invention relates generally to a heat weldable EPDM roofing membranes. More particularly, the present invention relates to a heat weldable EPDM roofing membrane including a film of thermoplastic elastomer (TPE) or thermoplastic polyolefin (TPO). A method is also provided for forming large sized sheets of heat weldable EPDM roofing membrane therefrom.

### BACKGROUND OF THE INVENTION

EPDM is used as a single ply roofing membrane material for covering industrial and commercial flat roofs. Such membranes are generally applied to the roof surface in a vulcanized or cured state. Because of outstanding weathering resistance and flexibility, cured EPDM based roofing membrane has rapidly gained acceptance. Notwithstanding the wide acceptance of EPDM based roofing membrane, a disadvantage of utilizing these elastomers is the lack of adhesion of EPDM, especially cured EPDM, to itself. Besides being highly labor intensive, this is a serious problem also because, in applying EPDM roofing membrane sheets to a roof, it is usually necessary to splice cured sheets of EPDM roofing membrane together. This splice or seam area is subjected to both short term and long term stresses such as those caused by roof movement, heavy winds, freeze-thaw cycling and thermal cycling. Such stresses may manifest themselves in shear forces or peel forces, i.e., the seam peels back under severe stress conditions or may cause a partially open seam (often referred to as a fish-mouth condition) under less severe conditions.

In view of the foregoing problem, it has been necessary to utilize an adhesive to bond the cured sheets of EPDM roofing membrane together. As will be evident from the above discussion, an adhesive for bonding cured sheets of EPDM roofing membrane together must meet a number of requirements which are extremely difficult to satisfy. Thus, the adhesive must provide sufficient seam peel and shear strength to permit the splice formed by bonding the cured sheets of EPDM roofing membrane together to resist both the short term and long term stresses such as those discussed hereinabove. Moreover, the adhesive must be resistant to oxidation, hydrolysis and chemical attack from pooled water. Additionally, the adhesive must develop virtually immediate adhesive strength when placed in contact with each other.

Adhesive compositions presently known, generally require anywhere from about two (2) to about seven (7) days at room temperature (i.e. 25° C.) to attain maximum adhesive seam strength. At higher ambient temperature, this time period may be somewhat less but at a minimum it will generally be at least 24 hours. The conventional procedure for splicing sheets of EPDM roofing membrane together is to make the splice within a relatively short period of time after the adhesive coating has been applied to each sheet, generally within 30 minutes but often less. Accordingly, the adhesive composition must provide sufficient immediate adhesive strength to permit the splice to withstand stresses from winds, movement, handling by installers, etc. until the adhesive achieves sufficient strength which as indicated will generally take from about 1 to 3 hours.

Commercial contact adhesives that are conventionally employed for bonding cured sheets of EPDM roofing membrane together generally consist of solutions of neoprene or neoprene-type or butyl or butyl-type polymer in aromatic or aromatic-aliphatic solvents containing 2-butanone often along with tackifying resins. However, such adhesives have not proven to be very satisfactory due to their lower than desirable seam peel adhesion strengths. Thus, the neoprene or butyl-type adhesives often provide peel adhesion values at 25° C. of only 1 to 2 pounds per linear inch. Additionally, the use of organic solvents in such systems would likely run afoul of environmental regulations, which control the release of volatile organics.

Pressure sensitive and contact adhesive compositions containing neutralized, partially neutralized or unneutralized sulfonate elastomers, tackifying resins and organic solvents or organic solvent mixtures are known in the prior art as shown by U.S. Pat. No. 3,801,531 and 3,867,247, incorporated herein by reference.

It is an object of the present invention to provide a sheet of EPDM roofing membrane having laminated to at least one side surface thereof a film of TPO or TPE which replaces traditional adhesives for seaming together two sheets of reinforced or unreinforced, cured EPDM roofing membrane. It is another object of the present invention to provide a TPE or TPO film for EPDM roofing membrane which eliminates the need for a solvent aqueous, non-solvent aqueous based splicing adhesive and the related labor and hardware necessary for mixing and application thereof. It is still another object of the present invention to provide a TPE or TPO film for seaming together two sheets of EPDM roofing membrane other olefin type roof roofing membrane, which can be joined and seamed together at their edges without the use of adhesives, either solvent, aqueous or non-solvent based. It is a further object of the present invention to provide a TPE of TPO film as described above which results in a water tight fit between two sheets of EPDM roofing membrane. Yet another object of the present invention is to provide a TPE or TPO film as described above which eliminates the use of organic solvents in seaming together EPDM roofing membrane. It is still another object of the present invention to provide a TPE or TPO film as described above which can be used to form a seam of variable width and hence varied strength between two layers of EPDM roofing membrane.

### SUMMARY OF THE INVENTION

Briefly, the present invention relates to a heat weldable roofing membrane including a substrate sheet formed of ethylene-propylene diene terpolymers; and a top film layer laminated to the substrate sheet and selected from TPE and TPO. The heat weldable roofing membrane may overlap another heat weldable roofing membrane to form a seam without the use of an adhesive.

A method for covering a roof is also provided and comprises the steps of laminating a TPO or TPE film to at least one surface of an EPDM sheet material; applying a second sheet of EPDM having laminated to at least one surface thereof a TPO or TPE film and overlapping the TPE or TPO film of each sheet; heating the overlapped areas to slightly above the peak melt temperature of the TPE or TPO film and seaming the overlapped areas using sufficient heat and pressure to provide an acceptable seam without the use of an adhesive. This seaming operation may be performed in the manufacturing facility or on the roof

### BRIEF DESCRIPTION OF THE DRAWING

Further features and other objects and advantages of this invention will become clear from the following detailed description made with reference to the drawings in which:

FIG. 1 is a partial perspective view of a sheet of EPDM roofing membrane in accordance with the present invention;

FIG. 2 is a partial perspective view of a plurality of sheets of EPDM roofing membrane in accordance with the present invention; and

FIG. 3 is an exploded partial perspective view of a sheet of EPDM roofing membrane in accordance with the present invention.

### DETAILED DESCRIPTION OF THE PREFERRED EMBODIMENTS

Referring to the figures, wherein like reference characters represent like elements, there is shown an EPDM roofing membrane 10 in accordance with the present invention. As noted, the roofing membrane used in the present invention comprises EPDM or other similar olefin type polymers. The term EPDM is intended to mean a terpolymer of ethylene, propylene and diene monomers with the residual unsaturation portion of the diene in the side chain. Illustrative methods for preparing such terpolymers are found in U.S. Pat. No. 3,280,082, the disclosure of which is incorporated herein by reference. The preferred polymers having from about 60 to about 95 weight percent ethylene and from about zero to about 12 weight percent of the diene with the balance of the polymer being propylene or some other similar olefin type monomer.

The diene monomer utilized in forming the EPDM terpolymer is preferably a non-conjugated diene. Illustrative examples of non-conjugated dienes which may be employed are dicyclopentadiene, alkyldicyclopentadiene, 1,4-pentadiene, 1,5-hexadiene, 1,4-heptadiene, 2-methyl-1,5-hexadiene, cyclooctadiene, 1,4-octadiene, 1,6-octadiene, 5-ethylidene-2-norbornene, 5-n-propylidene-2-norbornene, 5-(2-methyl-2-butenyl)-2-norbornene and the like. A typical EPDM is Vistalon® MD-744 (Exxon Chemical Co.) a terpolymer having a Mooney Viscosity (ML/4 at 125° C.) of about 52; an ethylene/propylene (E/P) ratio of 61/39 weight percent and 2.7 weight percent of unsaturation. (5-ethylidene-2-norbornene). Particularly useful and preferred in preparing a sulfur curable EPDM composition is Royalene® 3180 (Uniroyal Chemical Co.) which has a Mooney Viscosity (ML/4 at 125° C.) of about 54; an ethylene/propylene ratio of about 67/33 weight percent; about 2.2 weight percent of unsaturation; about 2.7 percent by weight of crystallinity and a weight average molecular weight of approximately 313,000 to 355,000. Also useful are thermoplastic heat seamable sheeting materials, i.e., EPDM's having a high degree of crystallinity as opposed to amorphous (non-crystalline) EPDM's. Examples thereof include Royalene® 375 (Uniroyal Chemical Co.); and EPsyn® 5508

The composition employed to form the sheeting material comprises 100 parts by weight of EPDM or other similar olefinic type polymers, including mixtures of two or more types, to which are added fillers and processing materials as well as optionally other components including curatives as well known in the art.

With respect first to the fillers, suitable fillers are selected from the group consisting of reinforcing and non-reinforcing materials, and mixtures thereof, as are customarily added to rubber. Examples include such materials as carbon black, ground coal, calcium carbonate, clay, silica, cryogenically ground rubber and the like. Preferred fillers include carbon black, ground coal and cryogenically ground rubber. Carbon black is used in an amount of about 20 parts to about 300 parts per 100 parts of polymer (phr), preferably about equal to the amount or carbon black normally used in preparing sulfur cured EPDM roof sheeting. The carbon black useful herein is any carbon black. Preferred are furnace blacks such as GPF (general purpose furnace), FEF (fast extrusion furnace) and SRF (semi-reinforcing furnace).

The ground coal employed as a filler in the compositions of the invention is a dry, finely divided black powder derived from a low volatile bituminous coal. The ground coal has a particle size ranging from a minimum of 0.26 microns to a maximum of 2.55 microns with the average particle size of 0.69±0.46 as determined on 50 particles, using Transmission Electron Microscopy. The ground coal produces an aqueous slurry having a pH of about 7.0 when tested in accordance with ASTM D-1512. A preferred ground coal of this type is designated Austin Black which has a specific gravity of 1.22±0.03, an ash content of 4.58% and a sulfur content of 0.65%. Austin Black is commercially available from Coal Fillers, Inc., P.O. Box 1063, Bluefield, Va. Amounts range from about 5 to 65 phm with about 15 to 35 being preferred.

Finally, essentially any cryogenically ground rubber may be employed as a filler in the composition of the invention. The preferred cryogenically ground rubbers are cryogenically ground EPDM, butyl, neoprene and the like. A preferred cryogenically ground rubber is a cryogenically ground EPDM rubber. The preferred cryogenically ground EPDM rubber is a fine black rubbery powder having a specific gravity of 1.129±0.015 and a particle size ranging from about 30 to about 300 microns with an average particle size ranging from about 50 to about 80 microns. Amounts range from about 5 to 40 phr with about 10 to 25 ph being preferred.

Mixtures of Austin black and cryogenically ground rubber useful herein may be utilized as a partial replacement for carbon black. Where mixtures of these two fillers are employed in the relative amounts thereof can be widely varied; the overall total not exceeding about 60 phr. The ratio of Austin black to cryogenically ground rubber may range from a desired ratio of 2:1 to perhaps even a ratio of 3:1. Again, as noted hereinabove, other filler materials can be employed. Amounts of these filler materials fall within the range of amounts normally employed in preparing sulfur cured conventional roof sheeting.

With respect to the processing material, it is included to improve the processing behavior of the composition (i.e. reduce mixing time and increase rate of sheet forming and includes processing oils, waxes and the like). The processing oil is included in an amount ranging from about 20 parts to about 150 parts process oil per 100 parts EPDM ingredient phr, preferably in an amount ranging from about 60 to about 100 phr. A preferred processing oil is a paraffinic oil, e.g. Sunpar 2280 which is available from the Sun Oil Company. Other petroleum derived oils including naphthenic oils may be used.

Optional ingredients include, for example, other elastomers (e.g., butyl elastomer, neutralized sulfonated EPDM, neutralized sulfonated butyl) in place of minor amounts of the EPDM, secondary inorganic fillers (e.g., talc, mica, clay, silicates, whiting) with total secondary filler content usually ranging from about 10 to about 150 phr. It is a feature of the present invention that the roof sheeting compound is fully cured prior to application.

The compounding ingredients can be admixed, utilizing an internal mixer (such as a Banbury mixer), an extruder, and/or a two-roll mill, or other mixers suitable for forming a viscous relatively uniform admixture. When utilizing a Banbury internal mixer, in a preferred mode, the dry or powdery materials such as carbon black are added first followed by the liquid process oil and finally the polymer (this type of mixing can be referred to as an upside-down mixing technique).

The resulting admixture is sheeted to a thickness ranging from 5 to 200 mils, preferably from 35 to 60 mils, by conventional sheeting methods, for example, milling, calendaring or extrusion. Preferably, the admixture is sheeted to at least 40 gauge (0.040 inches) which is the minimum thickness specified in standards set by the Roofing Council of the Rubber Manufacturers Association for non-reinforced black EPDM rubber sheets for use in roofing applications. In many cases, the admixture is sheeted to 40-45 gauge thickness since this is the thickness for a large percentage of “single-ply” roofing membranes used commercially. The sheeting can be cut to desired length and width dimensions at this time.

As shown in the figures, laminated to a top surface of the sheet of EPDM 14 to form a roofing membrane 10 is a thin film 12 of thermoplastic elastomer (TPE) or thermoplastic polyolefin (TPO). The term “thermoplastic elastomer” refers to an elastomer which can be melt-processed (as contrasted with conventional cross-linked rubbers). The TPE consists of a highly cross-linked rubbery polymer in combination with a thermoplastic polymer. The cross-linked rubbery phase may be a polymer comprised of ethylene-propylene-diene termonomer and the thermoplastic polymer may be a polyolefin.

The term “thermoplastic polyolefin” refers to uncrosslinked polyolefins that are thermoplastic. The thermoplastic polyolefins are made by blending ethylene-propylene polymers with polypropylene. The ethylene-propylene polymers may be blended with polypropylene by conventional mixing techniques. In an alternative embodiment, ethylene-propylene and polypropylene are made in a reactor simultaneously creating a homogenous mixture. The polymer is formulated with stabilizers, pigments and antioxidants to obtain the appropriate adhesive properties.

Preferred TPO's include ethylene-propylene rubber blended with polypropylene.

The TPE's and TPO's can be processed using conventional plastics techniques, such as injection molding, calendaring and extrusion to form a thin sheet or film.

The thin film 12 of TPE or TPO is laminated to a sheet of EPDM 14. The thin film 12 of TPE or TPO may be continuously extruded onto the sheet of EPDM as the EPDM exits the extrusion process or the TPE or TPO may be bonded to the EPDM under elevated temperature and pressure. Generally, the thickness of the film can range between from about 2-20 mils although greater or less thicknesses may be employed and thus, are not precluded.

Whichever process is employed to bond the thin film 12 of TPO or TPE to the EPDM 14, it has been found that to obtain an acceptable bond the surface of the EPDM must be clean and free of talc or release agent. Furthermore, the surface temperature of the EPDM 14 must be between about 171-193 degrees Celsius and the surface temperature of the TPO or TPE film 12 must be between about 204-223 degrees Celsius.

It will be appreciated that an EPDM 14 having a film 12 of TPO or TPE facilitates bonding of like roofing membranes 10 without the use of an adhesive. For example, in a typical installation, a first roofing membrane 10 of a composite of EPDM 14 and TPO or TPE film 12 is unrolled over a roof substructure in an otherwise conventional manner. The next roofing membrane 10 of EPDM 14 and TPO or TPE film 12 is then applied onto the roof overlapping the first roofing membrane to form a seam of a bottom sheet of EPDM and TPO or TPE film and a top sheet of TPO or TPE and EPDM film. The width of the seam can vary depending on the requirements specified by the architect, building contractor or roofing contractor and thus, does not constitute a limitation of the present invention. Generally, seam widths can vary between about 1 to 6 inches.

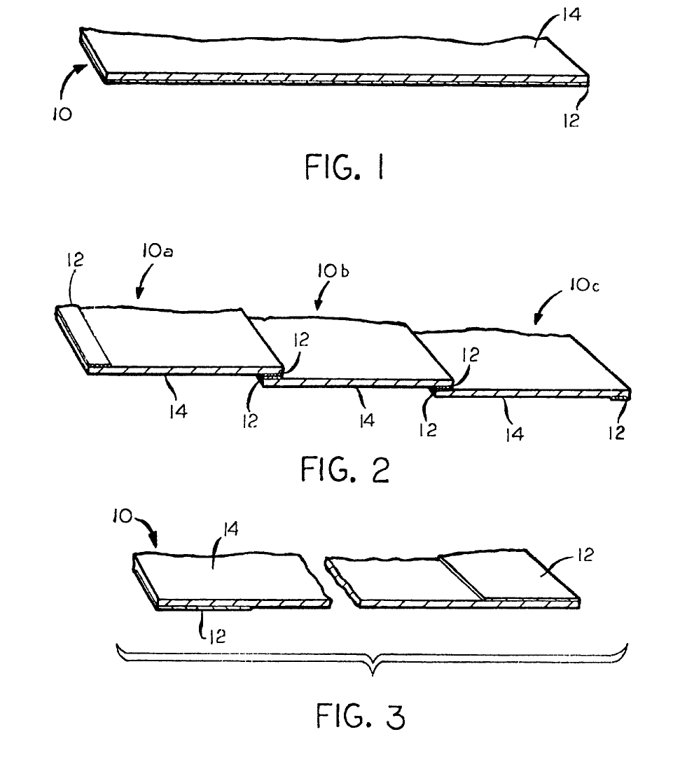

With reference to the drawing figures, FIG. 1 illustrates a roofing membrane 10 including a top sheet of EPDM 14 and a continuous film 12 of TPE or TPO laminated to one side of the top sheet. In an alternative embodiment, as shown in FIG. 3, the roofing membrane 10 includes a sheet of EPDM 14 and a film 12 of TPE or TPO laminated to an edge area of opposing sides of each sheet. As shown in FIG. 2, a roofing membrane 10a is illustrated with a lower surface, bottom edge area of the sheet overlapping the upper surface, top edge area of a roofing membrane 10b to form a seam. Similarly, roofing membrane 10b is illustrated with a lower surface, bottom edge area of the sheet overlapping the upper surface, top edge area of a sheet 10c of roofing membrane material. It will be appreciated that the overlapping step-wise pattern is continued to cover the entire roof deck. The TPO or TPE film 12 of the roofing membranes 10 are juxtaposed one from the other. Next, heat and pressure are applied to the overlapping edges of the two roofing membranes 10 to form a seam. At the location of the seam, temperature is conveniently applied above the melting point of the polymer, usually about 148-287 degrees Celsius, with a heat source, e.g., a Leister hand-held heating gun, and some pressure. Generally, the seam area should be heated slightly above the melt temperature of the TPO or TPE film. Pressure can vary widely from a minimum of about 3 psi to as high as 60 psi, typically so long as it is adequate to provide an acceptable, water tight seam.

The patents and documents described herein are hereby incorporated by reference.

Having described presently preferred embodiments of the invention, the invention may be otherwise embodied within the scope of the appended claims.

What is claimed is:

1. A heat weldable roofing membrane comprising:
a substrate sheet formed of ethylene-propylene diene terpolymer; and
a top film layer laminated to at least one side surface of the substrate sheet and selected from TPE and TPO.

2. The roofing membrane of claim 1 wherein the TPO comprises ethylene-propylene rubber blended with polypropylene.

3. The roofing membrane of claim 1 wherein the TPE comprises a highly cosslinked rubbery polymer in combination with a thermoplastic polymer.

4. The roofing membrane of claim 3 wherein the crosslinked rubbery phase may be a polymer comprised of ethylene-propylene-diene termonomer.

5. The roofing membrane of claim 4 wherein the thermoplastic polymer may be a polyolefin.
